(19) United States
(12) Patent Application Publication
(10) Pub. No.: US 2007/0105660 A1
(43) Pub. Date: May 10, 2007

(54) Polymerized metallocene catalyst compositions and the use thereof to produce golf ball compositions

(76) Inventors: Kevin M. Harris, New Bedford, MA (US); Murali Rajagopalan, South Dartmouth, MA (US)

Correspondence Address: ACUSHNET COMPANY, 333 BRIDGE STREET, P. O. BOX 965, FAIRHAVEN, MA, 02719, US

(21) Appl. No.: 11/267,488

(22) Filed: Nov. 4, 2005

(51) Int. Cl. A63B 37/06; C08F 4/42

(52) U.S. Cl. 473/374; 526/154; 526/157; 526/183

(57) ABSTRACT

The present invention is directed to golf balls having at least one layer which comprises a polymer produced by a process wherein at least one olefin is combined with a polymerized metallocene catalyst composition and an activator under polymerization conditions. Golf balls of the present invention include one-piece, two-piece, and multi-layer golf balls. In two-piece and multi-layer golf balls of the present invention, the polymer may be present in a core layer, a cover layer, an intermediate layer (in the case of multi-layer balls), or a combination thereof.

### FIELD OF THE INVENTION

The present invention relates to the use of polymerized metallocene catalyst compositions, prepared by polymerizing one or more free radical polymerizable monomers with one or more different catalyst precursors containing terminal unsaturation, to produce polymer compositions for use in golf balls.

### BACKGROUND OF THE INVENTION

Polymerized metallocene catalyst compositions are generally known. For example, U.S. patent application Publication No. 2004/0152591 discloses methods of polymerizing or oligomerizing one or more olefins using one or more activators with one or more polymerized catalyst compounds prepared by polymerizing (using a free radical initiator) one or more free radical polymerizable monomers (such as styrene) with one or more different catalyst precursors containing terminal unsaturation. The resulting polymers are disclosed as being useful in a variety of end use applications, but their use in golf ball applications is not disclosed.

The use of metallocene-catalyzed polymers in golf ball compositions is known. For example, U.S. Pat. No. 5,703,166 discloses golf ball compositions which contain blends of ionomers and non-ionic polyolefin polymers produced using metallocene catalysts. Also, U.S. Pat. No. 6,414,082 discloses golf balls having at least one layer comprising at least one polymer produced using a single-site metallocene catalyst in the polymerization process, to which at least one pendant functional group has been grafted by a post-polymerization reaction.

Conventional metallocene-catalyzed polymers generally have a narrow molecular weight distribution, which can lead to inferior processability in golf ball applications compared to polymers having a broad molecular weight distribution. Thus, there is a desire in the golf ball industry for metallocene-catalyzed polymer compositions having a broad molecular weight distribution (“MWD”). The present invention describes such compositions and their use in a variety of golf ball core and cover layers.

### SUMMARY OF THE INVENTION

In one embodiment, the present invention is directed to a golf ball having at least one layer which comprises a polymer of the present invention. Polymers of the present invention are produced by a process comprising combining at least one olefin with a polymerized catalyst composition and an activator under polymerization conditions. The polymerized catalyst composition comprises the product of combining, in the presence of a free radical initiator, a catalyst precursor and at least one monomer that is polymerizable by free-radical polymerization. The catalyst precursor is represented by one of the following formulas: 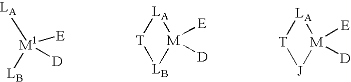
wherein
(a) M is a Group 3-10 metal; M¹ is a Group 3-10 metal;
(b) L_{A} is a substituted or unsubstituted, cyclopentadienyl or heterocyclopentadienyl ligand, and comprises R;
(c) L_{B} is
   (i) a ligand as defined for L_{A}, but selected independently of L_{A}, or
   (ii) J, a heteroatom ligand, and comprises a Group 14-15 atom and from 0 to 2 of R″;
(c) T is a bridging group that connects L_{A} and L_{B} and comprises a Group 13-16 element and from 0 to 2 of R′; and
(d) D and E are the same or different abstractable ligands;
wherein each R, R′, and R″ is independently selected from hydrogen and a hydrocarbyl group provided at least one of R, R′, and R″ can be polymerized by a free radical initiator, and provided that when M¹ is Zr, L_{A} is substituted at more than one carbon atom.

In another embodiment, the present invention is directed to a one-piece golf ball which comprises a polymer produced by a process comprising combining at least one olefin with a polymerized catalyst composition and an activator under polymerization conditions. The catalyst composition comprises the product of combining, in the presence of a free radical initiator, a catalyst precursor and at least one monomer that is polymerizable by free-radical polymerization. The catalyst precursor is generally represented by the formula L_{A} L_{B}L_{Ci} MDE, as further described below.

In another embodiment, the present invention is directed to a two-piece or multi-layer golf ball having at least one layer, such as a core layer, a cover layer, and/or an intermediate layer, which comprises a polymer produced by a process comprising combining at least one olefin with a polymerized catalyst composition and an activator under polymerization conditions. The catalyst composition comprises the product of combining, in the presence of a free radical initiator, a catalyst precursor and at least one monomer that is polymerizable by free-radical polymerization. The catalyst precursor is generally represented by the formula L_{A} L_{B} L_{Ci} MDE, as further described below.

### DETAILED DESCRIPTION OF THE INVENTION

Golf balls of the present invention include one-piece, two-piece (i.e., a core and a cover), multi-layer (i.e., a core of one or more layers and a cover of one or more layers), and wound golf balls, having a variety of core structures, intermediate layers, covers, and coatings. Golf ball cores may consist of a single, unitary layer, comprising the entire core from the center of the core to its outer periphery, or they may consist of a center surrounded by at least one outer core layer. The center, innermost portion of the core may be solid, hollow, or liquid-, gel-, or gas-filled. The outer core layer may be solid, or it may be a wound layer formed of a tensioned elastomeric material. Golf ball covers may also contain one or more layers, such as a double cover having an inner and outer cover layer. Additional layers may optionally be disposed between the core and cover. In the golf balls of the present invention, at least one layer comprises a polymer which is prepared using a polymerized metallocene catalyst composition as described below.

Catalyst Precursor

Polymerized metallocene catalyst compositions of the present invention are prepared by contacting a catalyst precursor with a free radical initiator and one or more monomers that can be polymerized by a free radical initiator. Representative catalyst precursors are metallocene compounds having the formula:
L_{A}L_{B}L_{Ci}MDE

where M is a Group 3-10 metal; L_{A} is a substituted or unsubstituted, cyclopentadienyl or heterocyclopentadienyl ligand connected to M; and L_{B} is a ligand as defined for L_{A}, but selected independently of L_{A}, or is J, a heteroatom ligand connected to M. L_{A} and L_{B} may connect to each other through a Group 13-16 element-containing bridge. L_{Ci} is an optional, neutral, non-oxidizing ligand connected to M (i equals 0 to 3); and D and E are the same or different labile ligands, optionally bridged to each other, L_{A}, or L_{B}. Each of D and E are connected to M. In a particular embodiment, M is a Group 3-6 transition metal. In another particular embodiment, M is a Group 4 transition metal. In yet another particular embodiment, M is selected from Ti, Zr, and Hf.

The identities of D and E are functionally constrained. The first constraint is that upon activation, either the D-M or the E-M connection must break. D and E should be chosen to facilitate this. Another constraint is that, during olefin polymerization, a polymerizable molecule must be able to insert between M and whichever of D or E remains. In a particular embodiment, D and E are independently selected from hydride radicals, hydrocarbyl radicals, and hydrocarbyl-substituted, organometalloid radicals. In another particular embodiment, D and E are independently selected from halogen, alkoxide, aryloxide, amide, and phosphide radicals. In another particular embodiment, D and E are independently selected from chloride, bromide, iodide, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hydride, phenyl, benzyl, phenethyl, tolyl, methoxy, ethoxy, propoxy, butoxy, dimethylamino, diethylamino, methylethylamino, phenoxy, benzoxy, allyl, 1,1-dimethyl allyl, 2-carboxymethyl allyl, acetylacetonate, 1,1,1,5,5,5-hexa-fluoroacetylacetonate, 1,1,1-trifluoro-acetylacetonate, and 1,1,1-trifluoro-5,5-di-methylacetylacetonate radicals.

Cyclopentadienyl and heterocyclopentadienyl ligands include fused-ring systems including, but not limited to, indenyl and fluorenyl radicals. For purposes of this specification, the term “cyclopentadienyl” includes heteroatom-containing rings or fused rings, where a non-carbon, Group 13, 14, 15, or 16 atom replaces a ring carbon. See, for example, the background and illustrations of PCT Publications WO 98/37106 and WO 98/41530, the entire disclosures of which are hereby incorporated herein by reference. Substituted cyclopentadienyl structures are structures in which one or more hydrogen atoms are replaced by a hydrocarbyl, hydrocarbylsilyl, or similar heteroatom-containing structure. Hydrocarbyl structures specifically include C₁-C₃₀ linear, branched, and cyclic, alkyl and aromatic, fused and pendant rings. These rings may also be substituted with ring structures. In particular, ancillary ligands that themselves contain cyclopentadienyl ligands are suitable for use as catalyst precursors when their ancillary ligands have been modified by adding an olefinic substitution, if this addition transforms the compound into a free-radical-polymerizable compound. Suitable examples of metallocene compounds in which ancillary ligands themselves contain cyclopentadienyl ligands include, but are not limited to, those described in U.S. patent application Publication No. 2004/0152591, the entire disclosure of which is hereby incorporated herein by reference.

In a particular embodiment, the catalyst precursor is represented by one of the following formulas: 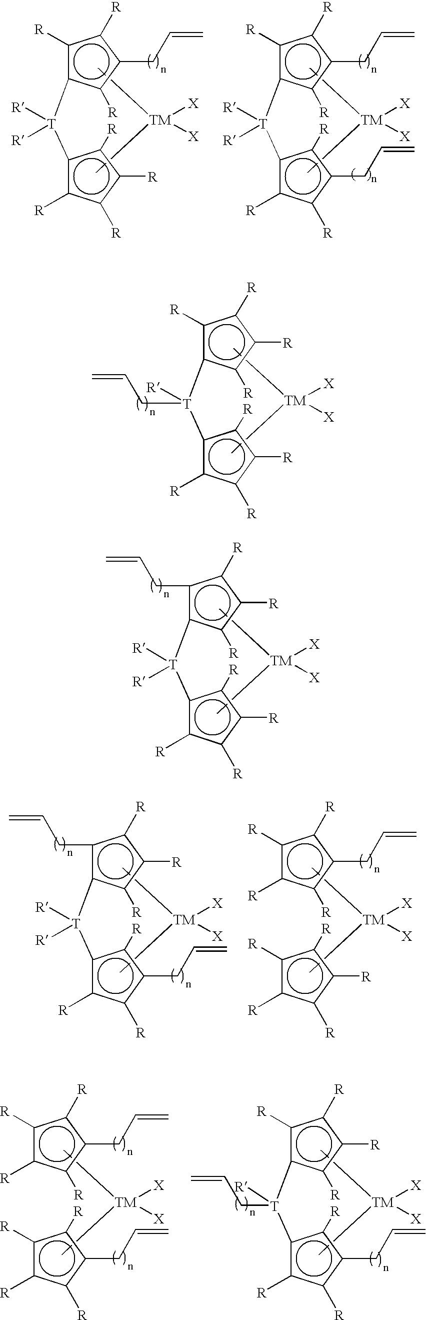 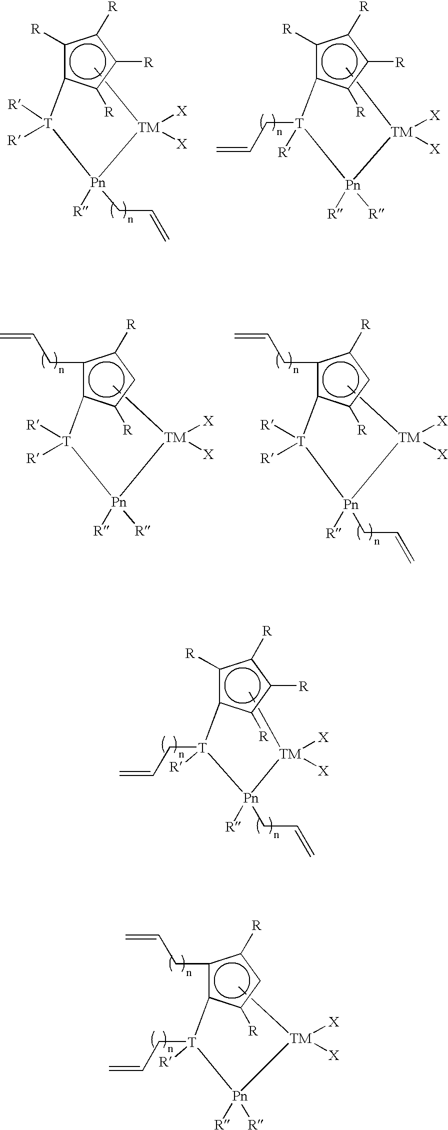 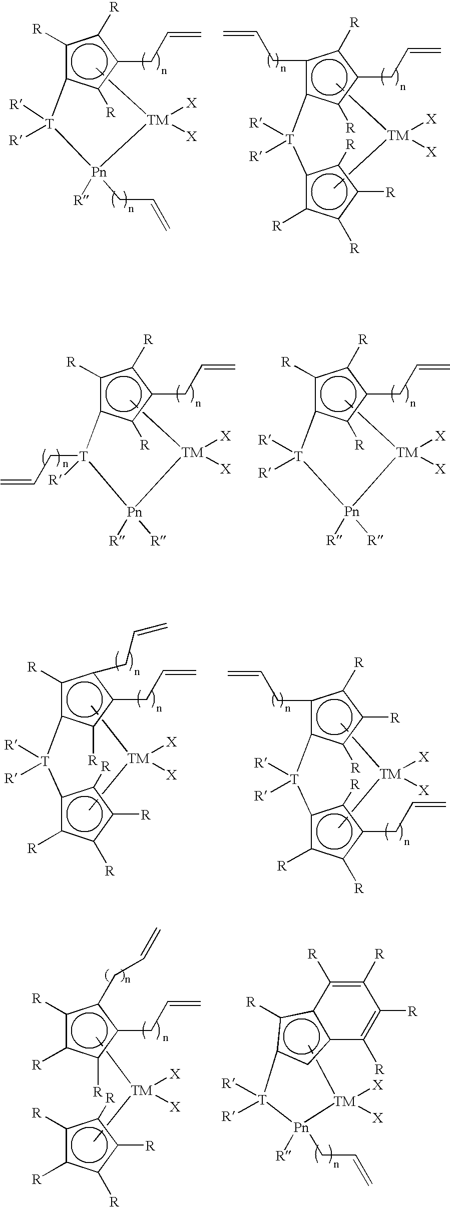 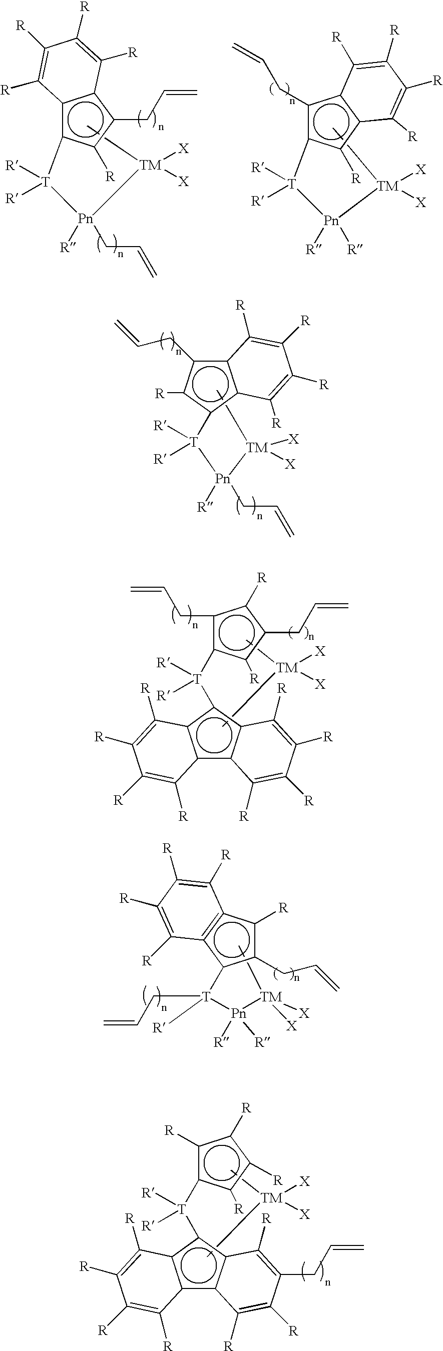 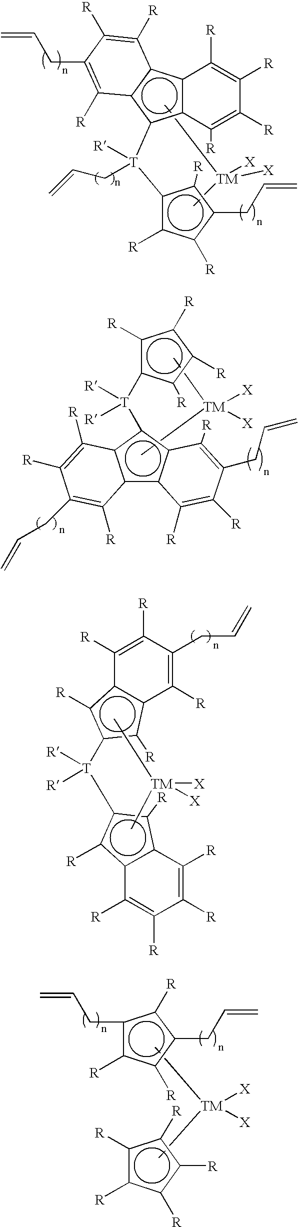 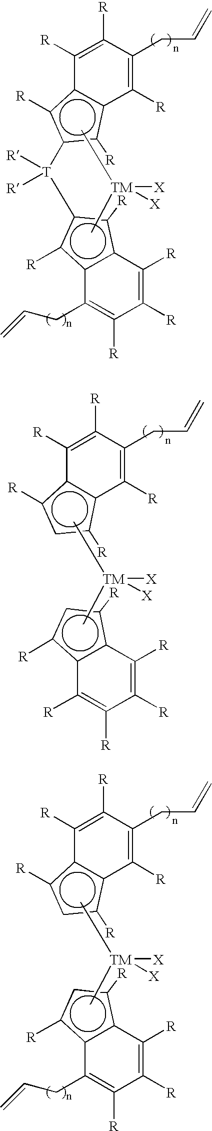
wherein
(a) TM is a Group 4-10 metal;
(b) each X is an independently selected abstractable ligand;
(c) each R, R′, and R″ is independently selected from hydrogen and a hydrocarbyl group provided at least one of R, R′, and R″ can be polymerized by a free radical initiator;
(d) n is 0-3; and
(e) Pn is a Group 14-15 atom.

Catalyst precursors of the present invention also include the mono- and biscyclopentadienyl compounds such as those described in U.S. Pat. Nos. 5,017,714 and 5,324,800, PCT Publication WO 92/00333, and European Patent No. 0591756, the entire disclosures of which are hereby incorporated herein by reference.

Process for Preparing the Polymerized Catalyst Precursor

The catalyst precursor is contacted with a free radical initiator and one or more free-radical-polymerizable monomers to produce a polymerized catalyst precursor. The following procedure is suitable for polymerizing the metallocene catalyst precursor. 50 ml of a toluene solution with the terminal-unsaturation-containing catalyst, styrene, and AIBN is kept at 80° C. for 7 hrs. The resulting solution is evaporated and residue is washed with dried mixture solution of hexane and toluene (2:1). The solid polymer product is collected. An analogous method can be used for preparation of other polymerized catalysts. The polymerization typically takes place in solution at a temperature of 30-100° C., 50-90° C., 70-85° C., or 75-85° C. Suitable solvents include toluene, benzene, xylene, and hexane. Desired solvents are selected from those that can dissolve the catalyst precursor. The polymerization may be performed at atmospheric, sub-atmospheric, or super-atmospheric pressures.

In a particular embodiment, prior to copolymerization of the catalyst precursor with one or more free-radical-polymerizable monomers, the catalyst precursor has the following structure. 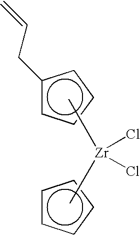
In a particular embodiment, the catalyst precursor has the following structure after copolymerization with a free-radical-polymerizable monomer. 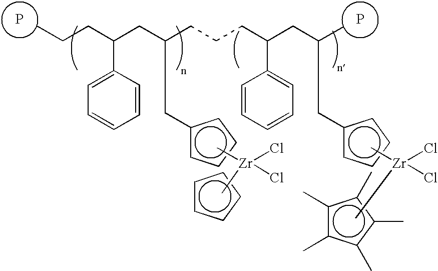
The P-labeled circles represent the bulk polyolefin/catalyst polymer.

The polymerized catalyst precursors typically have a weight average molecular weight (M_{w}) of up to 300,000; or 500-150,000; or 1,000-100,000; or 5,000-75,000; or 10,000-50,000.

Free Radical Initiators

Free radical initiators that are useful in this invention include: (1) thermally decomposable compounds which generate radicals, such as azo compounds and organic peroxides; (2) compounds which generate free radicals by non-thermal methods such as photochemical and redox processes; (3) compounds which have inherent radical character, such as molecular oxygen; and (4) electromagnetic radiation, such as X-rays, electron beams, visible light and ultraviolet light. Suitable organic peroxide compounds include hydroperoxides, dialkyl peroxides, diacyl peroxides, peroxyesters, peroxydicarbonates, peroxyketals, ketone peroxides, and organosulfonyl peroxides. In a particular embodiment, the organic peroxide is selected from t-butyl perbenzoate, dicumyl peroxide, 2,5-dimethyl-2,5-di-tert-butylperoxide-3-hexyne (e.g., Lupersol 130), and a,a-bis(tert-butylperoxy)diisopropyl benzene (e.g., VulCup R).

Any free radical initiator, or mixture thereof, having a 10-hour half-life temperature over 80° C. may function as the initiator to prepare supported polymerized catalyst compounds of the present invention. Reference is made to Modern Plastics, November 1971, pages 66-67, which is hereby incorporated herein by reference, for further examples of such compounds. The free radical initiator is typically used at concentrations of 1-5 wt % based on styrene.

In a particular embodiment, the free radical initiator is an organic peroxide compound having a half-life, at the reaction temperature, of less than one tenth of the reaction/residence time employed.

Further examples of free-radical initiators that are useful in polymerizing catalyst precursors of the present invention include, but are not limited to, azo initiators, such as dialkyldiazenes [e.g., 2,2′-azobis(2-methylpropanenitrile) (“AIBN”); 1,1-azobis(1-cyclohexanenitrile); 4,4′-azobis(4-cyanovaleric acid); and triphenylmethylazobenzene] and hypronitrites (e.g., di-t-butyl hyponitrite and dicumyl hyponitrite); and peroxides, such as diacyl peroxides (e.g., dibenzoyl peroxide, didodecanoyl peroxide, and diacetyl peroxide), dialkyl peroxydicarbonates (e.g., diisopropyl ester and dicyclohexyl ester), peresters, alkyl hydroperoxides (e.g., cumyl hydroperoxide and t-butyl hydroperoxide), dialkyl peroxides (e.g., dicumyl peroxide and di-t-butyl peroxide), and inorganic peroxides (e.g., hydrogen peroxide and persulfate).

Monomers Polymerizable by a Free Radical Initiator

Monomers that can be polymerized by a free radical process include, for example, ethylene, 1,3-butadiene, isoprene, styrene, vinyl styrene, alkyl styrene, isobutylene, vinyl chloride, vinylidene chloride, vinyl fluoride, tetrafluoroethylene, vinyl esters, acrylic esters, methacrylic esters, acrylonitrile, and propylene. Thus, any of these monomers, or a combination thereof, can be copolymerized with the catalyst precursor. For example, selecting isoprene for copolymerization results in a catalyst precursor/isoprene copolymer.

Activation of the Polymerized Catalyst Precursor

Combining the polymerized catalyst precursor described above with one or more activators forms an olefin polymerization catalyst. The activator functions to remove an abstractable ligand from the transition metal compound. After activation, the transition metal is left with an empty coordination site at which an incoming a-olefin can coordinate before it is incorporated into the polymer. Any reagent that can so function without destroying the commercial viability of the polymerization process is suitable for use as an activator in the present invention.

Examples of suitable activators include, but are not limited to, Lewis acid, non-coordinating ionic activators or ionizing activators, or any other compound that can convert a catalyst compound into a catalytically active cation. The present invention can use alumoxane or modified alumoxane as an activator, and can also use neutral or ionic ionizing activators, such as tri(n-butyl)ammonium tetrakis(pentafluorophenyl)boron; a trisperfluorophenyl boron metalloid precursor or a trisperfluoronaphthyl boron metalloid precursor; polyhalogenated heteroborane anions, such as those described in PCT Publication WO 98/43983, the entire disclosure of which is hereby incorporated by reference; and combinations thereof. The present invention can use these compounds as activators if they can ionize the transition metal compound of the catalyst precursor, or if the transition metal compound can be pre-reacted to form a compound that these activators can ionize.

Further examples of suitable activators include, but are not limited to, alumoxanes, such as methylalumoxane (“MAO”), modified methylalumoxane, ethylalumoxane, and the like; aluminum alkyls, such as trimethyl aluminum, triethyl aluminum, triisopropyl aluminum, and the like; alkyl aluminum halides, such as diethyl aluminum chloride, and the like; and alkyl aluminum alkoxides.

An alumoxane compound useful as an activator is typically an oligomeric aluminum compound represented by the formula (R″—Al—O)ₙ, which is a cyclic compound, or R″(R″—Al—O)ₙAlR″₂, which is a linear compound. Generally, R″ is independently a C₁-C₂₀ alkyl radical, for example, methyl, ethyl, propyl, butyl, pentyl, isomers thereof, and the like, and n is an integer from 1-50. Particularly useful are alumoxanes in which R″ is methyl and n is at least four. Another particularly useful alumoxane is MMAO-3A (modified methylaluminoxane, type 3A, in heptane), commercially available from Akzo Nobel Polymer Chemicals, Chicago, Ill.

For further descriptions of alumoxanes, modified alumoxanes, and processes for their preparation, reference is made to U.S. Pat. Nos. 4,665,208; 4,874,734; 4,908,463; 4,924,018; 4,952,540; 4,968,827; 5,041,584; 5,091,352; 5,103,031; 5,157,137; 5,204,419; 5,206,199; 5,235,081; 5,248,801; 5,308,815; 5,329,032; 5,391,529; 5,391,793; 5,416,229; 5,693,838; 5,731,253; 5,731,451; 5,744,656; 5,847,177; 5,854,166; 5,856, 256; and 5,939,346; European Patent Nos. 0279586, 0561476, 0594218, and 0586665; and PCT Publication WO 94/10180; the entire disclosures of which are hereby incorporated herein by reference.

An aluminum alkyl compound useful as an activator is represented by the formula R″AlZ₂. Generally, R″ is independently a C₁-C₂₀ alkyl radical, for example, methyl, ethyl, propyl, butyl, pentyl, isomers thereof, and the like, and each Z is independently R″ or a different univalent anionic ligand such as a halogen (e.g., Cl, Br, or I), an alkoxide (e.g., OR″), and the like. Particularly useful aluminum alkyls include triethylaluminum, diethylaluminum chloride, triisobutylaluminum, tri-n-octylaluminum, and the like.

When alumoxane or aluminum alkyl activators are used, the molar ratio of catalyst precursor to activator is from 1:1000 to 10:1, or from 1:500 to 1:1, or from 1:300 to 1:10.

Another class of suitable activators is discrete ionic activators. These are particularly useful when both abstractable ligands are hydride or hydrocarbyl. Examples of discrete ionic activators-include, but are not limited to, [Me₂PhNH][B(C₆F₅)₄], [Bu₃NH][BF₄], [NH₄][PF₆], [NH₄][SbF₆], [NH₄][AsF₆], [NH₄][B(C₆H₅)₄] and Lewis acidic activators, such as B(C₆F₅)₃ and B(C₆H₅)₃. Discrete ionic activators provide for an activated catalyst site and a relatively non-coordinating (or weakly coordinating) anion. Activators of this type are described in, for example, W. Beck, et al., Chem. Rev., vol. 88, p. 1405-1421 (1988); S. H. Strauss, Chem. Rev., vol. 93, p. 927-942 (1993); U.S. Pat. Nos. 5,198,401; 5,278,119; 5,387,568; 5,763,549; 5,807,939; 6,262,202; and PCT Publications WO93/14132, WO99/45042, WO01/30785, and WO01/42249; the entire disclosures of which are hereby incorporated herein by reference. These activator types also function when the abstractable ligand is not hydrocarbyl, if they are used with a compound capable of alkylating the metal, such as an alumoxane or aluminum alkyl.

When discrete ionic activators are used, the molar ratio of catalyst precursor to activator is from 10:1 to 1:10, or from 5:1 to 1:5, or from 2:1 to 1:2, or from 1.2:1 to 1:1.

Further examples of suitable activators include, but are not limited to, those described in PCT Publication WO98/07515, the entire disclosure of which is hereby incorporated herein by reference; e.g., tris(2,2′,2″-nonafluorobiphenyl)fluoroaluminate.

Combinations of activators, including combinations of activators from different classes (e.g., alumoxanes in combination with ionizing activators), can also be used. Such combination of activators is described in, for example, European Patent No. 0573120, PCT Publications WO94/07928 and WO95/14044, and U.S. Pat. Nos. 5,153,157 and 5,453,410, the entire disclosures of which are hereby incorporated herein by reference.

Also suitable are the activators disclosed in PCT Publication WO98/09996, which describes the use of perchlorates, periodates, and iodates, and their hydrates; PCT Publications WO98/30602 and WO98/30603, which describe the use of lithium (2,2′-bisphenyl-ditrimethylsilicate)•4THF; PCT Publication WO99/18135, which describes the use of organo-boron-aluminum activators; and European Patent No. 0781299, which describes using a silylium salt in combination with a non-coordinating compatible anion.

Activation methods using irradiation, as described, for example, in European Patent No. 0615981, the entire disclosure of which is hereby incorporated herein by reference, electrochemical oxidation, and the like, are also suitable for activating the catalyst precursors of the present invention. Reference is made to U.S. Pat. Nos. 5,849,852; 5,859,653; and 5,869,723; and PCT Publications WO98/32775 and WO99/42467, the entire disclosures of which are hereby incorporated herein by reference, for other suitable activators and activation methods.

Polymerization Processes Using the Polymerized Catalyst Compound

The polymerized catalyst compound described above is suitable for use in polymerization processes wherein a polymer is produced by combining at least one olefin with the polymerized catalyst compound and an activator under polymerization conditions. The polymerization process is selected from solution processes, gas-phase processes, slurry processes, and combinations thereof. These well-known polymerization processes, including the use of polymerized catalyst compounds therein, are more fully described in U.S. patent application Publication No. 2004/0152591, the entire disclosure of which is hereby incorporated herein by reference.

Suitable olefins include C₂-C₃₀ olefins, particularly C₂-C₁₂ olefins, and more particularly C₂-C₈ olefins. Specific examples of suitable olefins include, but are not limited to, ethylene, propylene, butene-1, pentene-1, 4-methyl-pentene-1, hexene-1, octene-1, decene-1, 3-methyl-pentene-1, cyclic olefins, and combinations thereof. Other suitable olefins include, but are not limited to, vinyl monomers and diolefin monomers, such as monomers of dienes, polyenes, norbornene, norbornadiene, vinyl norbornene, and ethylidene norbornene.

In a particular embodiment, the polymerization process of the present invention produces homopolymers or copolymers of ethylene or propylene, including terpolymers of ethylene or propylene, such as propylene/butene-1/hexene-1, propylene/butene-1/ethylene, propylene/ethylene/hexene-1, propylene/butene/norbornene, propylene/butene/decadiene, and the like.

In one embodiment, the polymer of the present invention has a Shore D hardness, as measured according to ASTM D2240, of from 20 to 80, preferably from 30 to 70. In another embodiment, the polymer of the present invention has a flexural modulus, as measured using flex bars prepared and measured according to ASTM D790, of from 2,000 psi to 150,000 psi, preferably from 10,000 psi to 80,000 psi. In yet another embodiment, the polymer of the present invention has a weight average molecular weight (M_{w}) of from 50,000 to 200,000.

Functionalized Polymers

Polymers produced by the present invention may optionally be functionalized; for example, by sulfonation, carboxylation, addition of an amine or hydroxy group, or by grafting an unsaturated monomer onto the polymer using a post-polymerization reaction. Suitable unsaturated monomers for use in grafting include, but are not limited to, unsaturated acids and anhydrides, including any unsaturated organic compound containing at least one double bond and at least one carbonyl group (—C═O). Representative acids include, for example, carboxylic acids, anhydrides, esters, and their metallic and non-metallic salts. In some embodiments, the grafting monomer contains an ethylenic unsaturation conjugated with a carbonyl group. Examples include, but are not limited to, maleic, fumaric, acrylic, methacrylic, itaconic, crotonic, a-methyl crotonic, and cinnamic acids, as well as their anhydrides, esters, and salt derivatives. The unsaturated acid or anhydride is typically present in an amount of from 0.1 to 10 wt %, or from 0.5 to 7 wt %, or from 1 to 4 wt %, based on the combined weight of the hydrocarbon resin and the unsaturated acid or anhydride. Suitable grafting monomers also include ethylenically unsaturated olefinic monomers having a functional group selected from sulfonic acid, sulfonic acid derivatives, chlorosulfonic acid, vinyl ethers, vinyl esters, primary amines, secondary amines, tertiary amines, monocarboxylic acids, dicarboxylic acids, partially or fully ester derivatized monocarboxylic acids, partially or fully ester derivatized dicarboxylic acids, anhydrides of dicarboxylic acids, cyclic imides of dicarboxylic acids and ionomeric derivatives thereof. In a particular embodiment, the grafting monomer is maleic anhydride.

In one embodiment, the present invention provides a grafted polymer, wherein an ethylenically unsaturated monomer is grafted onto an ethylene homopolymer or copolymer, and wherein the ethylene homopolymer of copolymer is produced by the polymerized metallocene catalyst compound of the present invention. In a particular aspect of this embodiment, the ethylene copolymer is a copolymer of ethylene and a comonomer selected from propylene, butene, pentene, hexene, heptene, octene, and norbornene. In another embodiment, the present invention provides a grafted polymer, wherein an ethylenically unsaturated monomer is grafted onto a polymer produced by a polymerized metallocene catalyst compound, wherein the polymer is represented by the formula:
—(R₁CHCHR₂)ₓ(R₃CHCHR₄)_{y}(R₅CHCHR₆)_{z}—
wherein R₁ is hydrogen; R₂ is hydrogen or a lower alkyl selected from CH₃, C₂H₅, C₃H₇, C₄H₉, and C₅H₁₁; R₃ is hydrogen or a lower alkyl selected from CH₃, C₂H₅, C₃H₇, C₄H₉, and C₅H₁₁; R₄ is selected from H, CH₃, C₂H₅, C₃H₇, C₄H₉, C₅H₁₁, C₆H₁₃, C₇H₁₅, C₈H₁₇, C₉H₁₉, C₁₀H₂₁, and phenyl, in which from 0 to 5 H can be replaced by substituents selected from COOH, SO₃H, NH₂, F, Cl, Br, I, OH, SH, silicone lower alkyl esters and lower alkyl ethers, provided that R₃ and R₄ can optionally be combined to form a bicyclic ring; R₅ is hydrogen, a lower alkyl including C₁-C₅, a carbocyclic, an aromatic, or a heterocyclic; R₆ is hydrogen, a lower alkyl including C₁-C₅, a carbocyclic, an aromatic, or a heterocyclic; and wherein x ranges from 50 to 99 wt % of the polymer, y ranges from 1 to 50 wt % of the polymer, and z ranges from 0 to 49 wt % of the polymer, based on the total weight of the polymer. Such polymer, including the grafting thereof, is further described in U.S. Pat. No. 5,981,658, the entire disclosure of which is hereby incorporated herein by reference.

Methods for the post-polymerization grafting of polymers are well known. For example, the grafted polymer of the present invention may be formed by admixing the polymer with a monomer capable of bonding to the polymer and an organic peroxide, and mixing the admixture at a temperature greater than the melting point of the polymer for a time sufficient for the post-polymerization reaction to occur. Such a method is described more fully, for example, in European Patent Application No. 0266994A2, the entire disclosure of which is hereby incorporated herein by reference.

Blends

In some embodiments, a grafted or ungrafted polymer produced by the present invention is blended with one or more other polymers, such as thermoplastic polymers and elastomers. The invention polymer is generally present in such blends in an amount of from 10 to 99 wt %, or from 20 to 95 wt %, or from 30 to 90 wt %, or from 40 to 90 wt %, or from 50 to 90 wt %, or from 60 to 90 wt %, or from 70 to 90 wt %, based on the total polymeric weight of the blend.

Examples of thermoplastic polymers suitable for blending with the invention polymers include, but are not limited to, polyolefins, polyamides, polyesters, polyethers, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, ionomers, acid copolymers, highly neutralized polymers (“HNPs”), polyurethanes, and combinations thereof. Particular polyolefins suitable for blending include one or more, linear, branched, or cyclic, C₂-C₄₀ olefins, particularly polymers comprising ethylene or propylene copolymerized with one or more C₂-C₄₀ olefins, C₃-C₂₀ a-olefins, or C₃-C₁₀ a-olefins. Particular HNPs suitable for blending include, but are not limited to, one or more of the HNPs disclosed in U.S. Pat. Nos. 6,756,436, 6,894,098, and 6,953,820, the entire disclosures of which are hereby incorporated herein by reference.

Examples of elastomers suitable for blending with the invention polymers include all natural and synthetic rubbers, including, but not limited to, ethylene propylene rubber (“EPR”), ethylene propylene diene rubber (“EPDM”), styrenic block copolymer rubbers (such as SI, SIS, SB, SBS, SIBS, and the like, where “S” is styrene, “I” is isobutylene, and “B” is butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, and polybutadiene rubber (cis and trans).

In a particular embodiment, a grafted or ungrafted polymer produced by the present invention is blended with one or more of the following: isotactic polypropylenes; highly isotactic polypropylenes; syndiotactic polypropylenes; random copolymers of propylene and ethylene; random copolymers of propylene and butene; random copolymers of propylene and hexene; low-density polyethylenes (density 0.915 to 0.935 g/cm³); linear-low-density polyethylenes; ultra-low-density polyethylenes (density 0.86 to 0.90 g/cm³); very-low-density polyethylenes (density 0.90 to 0.915 g/cm³); medium-density polyethylenes (density 0.935 to 0.945 g/cm³); high-density polyethylenes (density 0.945 to 0.98 g/cm³); ethylene vinyl acetates; ethylene methyl acrylates; copolymers of acrylic acid, polymethylmethacrylate, or any other polymers polymerizable by high-pressure free radical processes; polyvinylchlorides; polybutenes; isotactic polybutenes; ABS resins; EPR; vulcanized EPR; EPDM; block copolymers; styrenic block copolymers; polyamides; polycarbonates; polyethylene terephthalate resins; crosslinked polyethylenes; copolymers of ethylene and vinyl alcohol (“EVOH”); or polymers of aromatic monomers such as polystyrene; poly-1-esters; polyacetal; polyvinylidine fluoride; polyethylene glycols; and polyisobutylenes. Additional suitable blend polymers include those described in U.S. Pat. No. 5,981,658, for example at column 14, lines 30 to 56, the entire disclosure of which is hereby incorporated herein by reference.

In another embodiment, rubber-toughened compositions are produced by blending a polymer produced by the present invention with one or more elastomers. In another embodiment, polymers produced by the present invention are blended to form impact copolymers. In yet another embodiment, polymers produced by the present invention are combined with metallocene polypropylenes, such as the EXCEED™, ACHIEVE™, and EXACT™ polymers commercially available from ExxonMobil Chemical Company, Baytown, TX.

The blends described herein may be produced by post-reactor blending, by connecting reactors in series to make reactor blends, or by using more than one catalyst in the same reactor to produce multiple species of polymer. The polymers may be mixed prior to being put into an extruder, or they may be mixed in an extruder.

Invention polymers, and blends containing invention polymers, may also contain tackifiers, such as aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resins, hydrogenated aliphatic aromatic resins, hydrogenated terpenes and modified terpenes, and hydrogenated rosin esters. The tackifier is optionally functionalized by contacting the resin with an unsaturated acid or anhydride.

Invention polymers, and blends containing invention polymers, may also contain a crosslinking agent, particularly those having functional groups that can react with an acid or anhydride group. Nonexclusive examples include alcohols, polyols, amines, diamines, and triamines. Particularly useful crosslinking agents are polyamines, such as ethylenediamine diethylenetriamine, hexamethylenediamine, diethylaminopropylamine, and menthanediamine.

Invention polymers, and blends containing invention polymers, may also contain additives known in the art, such as fillers, cavitating agents, foaming agents, and nucleating agents, including, but not limited to, metals and metal compounds, zinc oxide, titanium dioxide, calcium carbonate, barium sulfate, silica, silicon dioxide, carbon black, sand, glass beads, mineral aggregates, talc, clay, and the like; antioxidants (e.g., phenolic antioxidants, such as Irganox 1010 and Irganox 1076, commercially available from Ciba-Geigy); oils (e.g., paraffinic and naphthenic oils, such as Primol 352 and Primol 876, commercially available from ExxonMobil Chemical France, aliphatic naphthenic oils, white oils, and the like); plasticizers and adjuvants (e.g., mineral oils, polybutenes, phthalates, such as diisoundecyl phthalate, diisononyl phthalate, and the like); surfactants; antiblock additives; color masterbatches pigments, and dyes; processing aids, lubricants, and waxes (e.g., polar and non-polar waxes, functionalized waxes, polypropylene waxes, polyethylene waxes, wax modifiers, and long chain organic fatty acids and salts thereof); UV stabilizers; and neutralizers. Such additives are typically present in an amount of from 0.001 to 10 wt %, based on the total weight of the composition.

Further examples of suitable additives include those described in U.S. patent application Publication No. 2003/0225197, the entire disclosure of which is hereby incorporated herein by reference.

Golf Equipment Applications

Polymer compositions according to the present invention can be used in a variety of applications. For example, the polymer compositions are suitable for use in golf equipment, including, but not limited to, golf balls, shoes, clubs, and gloves.

In golf balls of the present invention, at least one layer comprises a polymer which is prepared using a polymerized metallocene catalyst composition as described herein. In a particular embodiment, the polymer is prepared using a polymerized metallocene catalyst composition as described in U.S. patent application 2004/0152591, the entire disclosure of which is hereby incorporated herein by reference. In another particular embodiment, the polymer is prepared in an ethylene slurry polymerization process using polymerized [(CH₂═CHCH₂Cp)₂ZrCl₂] metallocene catalyst precursor and MAO activator, as shown in U.S. patent application 2004/0152591 at paragraph [0189] and in Table 8. Golf balls of the present invention can be wound, one-piece, two-piece, or multi-layer balls, so long as at least one layer comprises a polymer prepared using the polymerized metallocene catalyst composition. In golf balls having two or more layers which comprise an invention polymer, the invention polymer of one layer may be the same or a different invention polymer as another layer. The layer(s) comprising the invention polymer can be any one or more of a core layer, an intermediate layer, or a cover layer.

In a particular embodiment, the golf ball is a one-piece golf ball comprising a polymer produced by a process comprising combining at least one olefin with a polymerized metallocene catalyst composition and an activator under polymerization conditions.

In another particular embodiment, the golf ball is a two-piece or multi-layer ball wherein at least one layer comprises a polymer produced by a process comprising combining at least one olefin with a polymerized metallocene catalyst composition and an activator under polymerization conditions. The polymer may be present in a core layer, a cover layer, an intermediate layer (in the case of multi-layer balls), or a combination thereof.

In yet another particular embodiment, the invention provides a multi-layer ball having a compression molded rubber core, at least one injection or compression molded intermediate layer which comprises an invention polymer, and a polyurethane or polyurea outer cover layer. The polyurethane or polyurea outer cover layer material can be thermoset or thermoplastic. Thermoset materials can be formed into golf ball layers by conventional casting or reaction injection molding techniques. Thermoplastic materials can be formed into golf ball layers by conventional compression or injection molding techniques. Light stable polyureas and polyurethanes are preferred for outer cover layer materials. Preferably, the rubber core composition comprises a base rubber, a crosslinking agent, a filler, a co-crosslinking or initiator agent, and a cis to trans converting material (e.g., organosulfur and inorganic sulfur compounds). Typical base rubber materials include natural and synthetic rubbers, including, but not limited to, polybutadiene and styrene-butadiene. The crosslinking agent typically includes a metal salt, such as a zinc salt or magnesium salt, of an acid having from 3 to 8 carbon atoms, such as (meth) acrylic acid. The initiator agent can be any known polymerization initiator which decomposes during the cure cycle, including, but not limited to, dicumyl peroxide, 1,1-di-(t-butylperoxy) 3,3,5-trimethyl cyclohexane, a-a bis-(t-butylperoxy)diisopropylbenzene, 2,5-dimethyl-2,5 di-(t-butylperoxy)hexane or di-t-butyl peroxide, and mixtures thereof. Suitable types and amounts of base rubber, crosslinking agent, filler, co-crosslinking agent, and initiator agent are more fully described in, for example, U.S. patent application Publication No. 2003/0144087, the entire disclosure of which is hereby incorporated herein by reference. Reference is also made to U.S. patent application Publication No. 2003/0144087 for various ball constructions and materials that can be used in golf ball core, intermediate, and cover layers.

The present invention is not limited by any particular process for forming the golf ball layer(s). It should be understood that the layer(s) can be formed by any suitable technique, including injection molding, compression molding, casting, and reaction injection molding.

Golf balls of the present invention generally have a coefficient of restitution (“COR”) of at least 0.790, preferably at least 0.800, more preferably at least 0.805, and even more preferably at least 0.810, and an Atti compression of from 75 to 110, preferably from 90 to 100. As used herein, COR is defined as the ratio of the rebound velocity to the inbound velocity when balls are fired into a rigid plate. In determining COR, the inbound velocity is understood to be 125 ft/s.

When numerical lower limits and numerical upper limits are set forth herein, it is contemplated that any combination of these values may be used.

All patents, publications, test procedures, and other references cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A golf ball having at least one layer which comprises a polymer produced by a process comprising:
combining at least one olefin with a polymerized catalyst composition and an activator under polymerization conditions;
wherein the polymerized catalyst composition comprises the product of combining, in the presence of a free radical initiator, a catalyst precursor and at least one monomer wherein the monomer is polymerizable by free-radical polymerization, and wherein the catalyst precursor is represented by one of the following formulas: 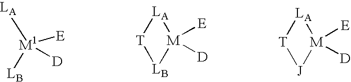
wherein
(a) M is a Group 3-10 metal; M¹ is a Group 3-10 metal;
(b) L_{A} is a substituted or unsubstituted, cyclopentadienyl or heterocyclopentadienyl ligand, and comprises R;
(c) L_{B} is
(i) a ligand as defined for L_{A}, but selected independently of L_{A}, or
(ii) J, a heteroatom ligand, and comprises a Group 14-15 atom and from 0 to 2 of R″;
(c) T is a bridging group that connects L_{A} and L_{B} and comprises a Group 13-16 element and from 0 to 2 of R′; and
(d) D and E are the same or different abstractable ligands;
wherein each R, R′, and R″ is independently selected from hydrogen and a hydrocarbyl group provided at least one of R, R′, and R″ can be polymerized by a free radical initiator, and provided that when M¹ is Zr, L_{A} is substituted at more than one carbon atom.

2. The golf ball of claim 1, wherein D and E are independently selected from chloride, bromide, iodide, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hydride, phenyl, benzyl, phenethyl, tolyl, methoxy, ethoxy, propoxy, butoxy, dimethylamino, diethylamino, methylethylamino, phenoxy, benzoxy, allyl, 1,1-dimethyl allyl, 2-carboxymethyl allyl, acetylacetonate, 1,1,1,5,5,5-hexa-fluoroacetylacetonate, 1,1,1-trifluoro-acetylacetonate, and 1,1,1-trifluoro-5,5-di-methylacetylacetonate radicals.

3. The golf ball of claim 1, wherein said monomer polymerizable by free-radical polymerization is selected from one or more of styrene, vinyl styrene, alkyl styrene, isobutylene, isoprene, butadiene, ethylene, and propylene.

4. The golf ball of claim 1, wherein said activator is selected from alumoxanes, aluminum alkyls, alkyl aluminum halides, alkylaluminum alkoxides, discrete ionic activators, and Lewis acid activators.

5. The golf ball of claim 1, wherein said olefin is selected from one or more of ethylene, propylene, butene-1, pentene-1, 4-methyl-pentene-1, hexene-1, octene-1, decene-1, 3-methyl-pentene-1, vinyl monomers, and diolefin monomers.

6. The golf ball of claim 1, wherein said process further comprises grafting an unsaturated monomer onto the polymer.

7. The golf ball of claim 6, wherein said unsaturated monomer is selected from maleic acid, fumaric acid, acrylic acid, methacrylic acid, itaconic acid, crotonic acid, a-methyl crotonic acid, cinnamic acid, anhydrides thereof, esters thereof, and salt derivatives thereof.

8. The golf ball of claim 1, wherein said polymer is selected from homopolymers and copolymers of ethylene and propylene.

9. The golf ball of claim 1, wherein said polymer has a Shore D hardness of from 20 to 80.

10. The golf ball of claim 1, wherein said polymer has a flexural modulus of from 2,000 psi to 150,000 psi.

11. The golf ball of claim 1, wherein said polymer has a weight average molecular weight (M_{w}) of from 50,000 to 200,000.

12. The golf ball of claim 1, wherein said catalyst precursor is [(CH₂═CHCH₂Cp)₂ZrCl₂] and said activator is MAO.

13. The golf ball of claim 12, wherein said polymer has an M_{w}/Mₙ of at least 2.7.

14. The golf ball of claim 1, wherein said golf ball is a one-piece golf ball.

15. The golf ball of claim 1, wherein said golf ball comprises a core and a cover, and wherein said polymer is present in the core.

16. The golf ball of claim 1, wherein said golf ball comprises a core and a cover, and wherein said polymer is present in the cover.

17. The golf ball of claim 1, wherein said polymer is present in an intermediate layer located between a core and a cover.

18. A golf ball comprising a polybutadiene core, a cast or injection molded or reaction injection molded polyurethane or polyurea outer cover layer, and an intermediate layer located between the core and the outer cover layer, wherein the intermediate layer comprises a polymer produced by a process comprising:
combining at least one olefin with a polymerized catalyst composition and an activator under polymerization conditions;
wherein the polymerized catalyst composition comprises the product of combining, in the presence of a free radical initiator, a catalyst precursor and at least one monomer wherein the monomer is polymerizable by free-radical polymerization, and wherein the catalyst precursor is represented by one of the following formulas: 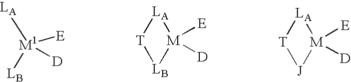
wherein
(a) M is a Group 3-10 metal; M¹ is a Group 3-10 metal;
(b) L_{A} is a substituted or unsubstituted, cyclopentadienyl or heterocyclopentadienyl ligand, and comprises R;
(c) L_{B} is
(i) a ligand as defined for L_{A}, but selected independently of L_{A}, or
(ii) J, a heteroatom ligand, and comprises a Group 14-15 atom and from 0 to 2 of R″;
(c) T is a bridging group that connects L_{A} and L_{B} and comprises a Group 13-16 element and from 0 to 2 of R′; and
(d) D and E are the same or different abstractable ligands;
wherein each R, R′, and R″ is independently selected from hydrogen and a hydrocarbyl group provided at least one of R, R′, and R″ can be polymerized by a free radical initiator, and provided that when M¹ is Zr, L_{A} is substituted at more than one carbon atom.

19. The golf ball of claim 18, wherein said polymer is selected from homopolymers and copolymers of ethylene and propylene.

20. The golf ball of claim 18, wherein said catalyst precursor is [(CH₂═CHCH₂Cp)₂ZrCl₂], said activator is MAO, and said polymer has an M_{w}/Mₙ of at least 2.7.
